(19) United States
(12) Patent Application Publication
(10) Pub. No.: US 2006/0123646 A1
(43) Pub. Date: Jun. 15, 2006

(54) V-level

(76) Inventor: Robert Michael McRae, Interlachen, FL (US)

Correspondence Address: ROBERT MICHAEL McRAE, 549 Interlachen Blvd., Interlachen, FL, 32148, US

(21) Appl. No.: 11/010,924

(22) Filed: Dec. 14, 2004

(51) Int. Cl. B43L 7/00

(52) U.S. Cl. 33/451

(57) ABSTRACT

The V-Level will give an accurate and an exact level reading, rather than having to read an ordinary level twice, to obtain a level or plumb of two perpendicular planes, at a ninety degree angle to each other. You can now have six bubbles to level, plum, and square, ‘exactly’ in one movement. Leveling walls, floors, tile, and framing can be done in one simple step.

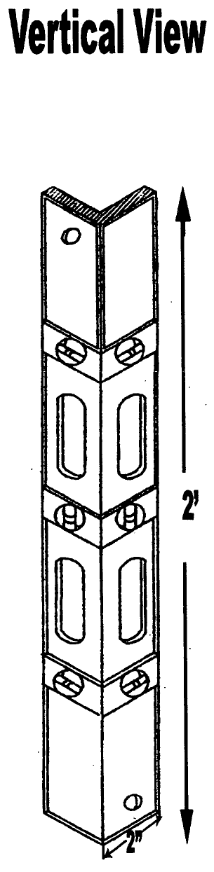

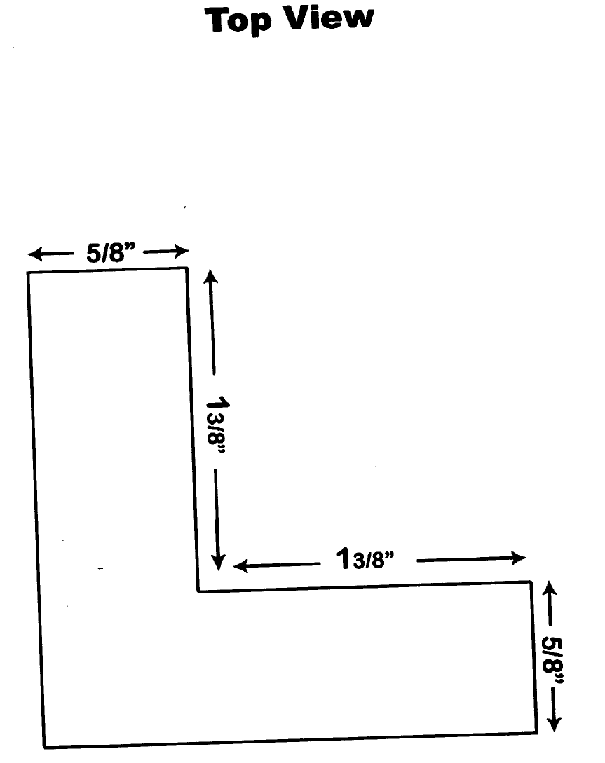

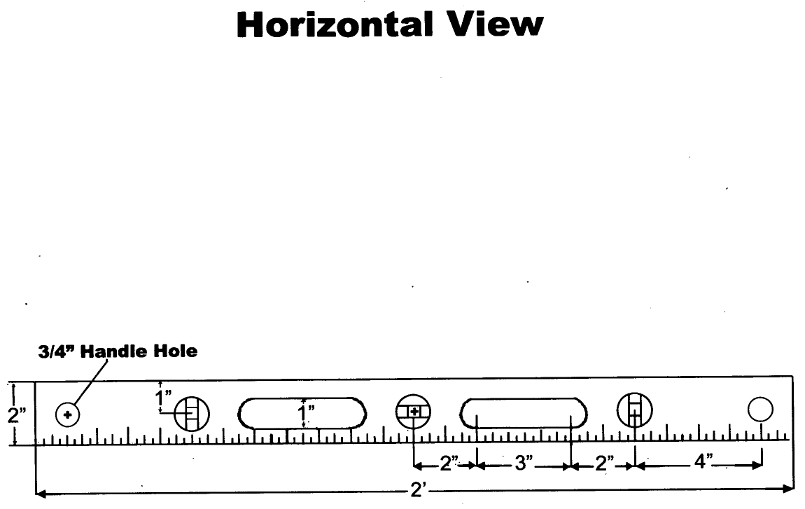

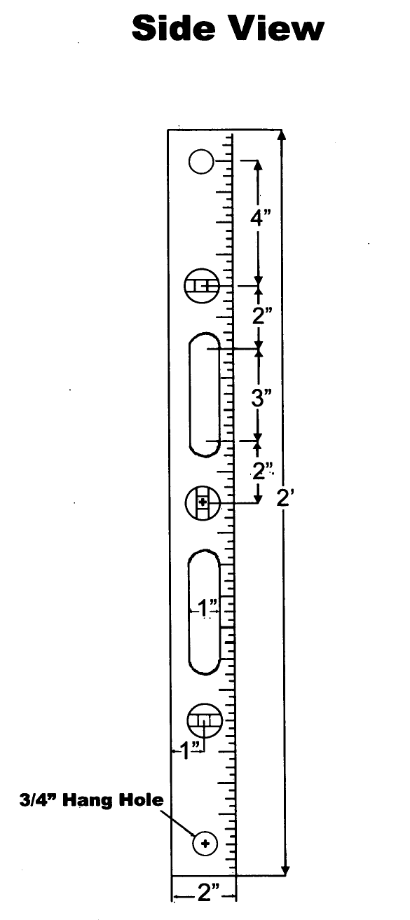

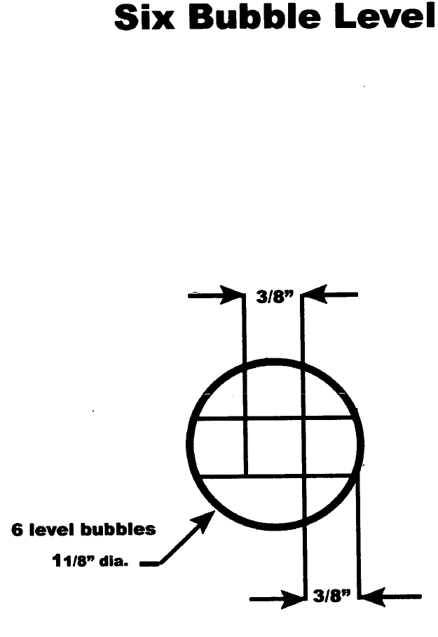

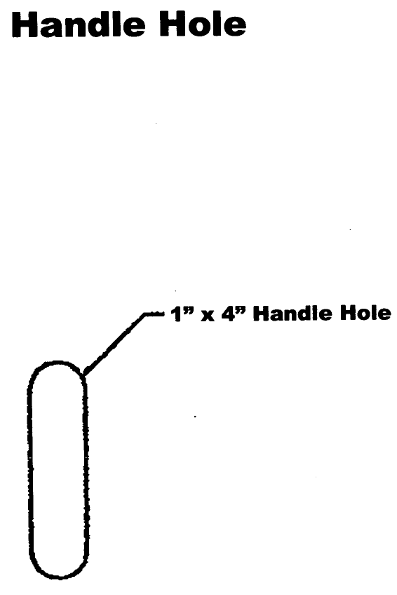

### BACKGROUND OF THE INVENTION

### Technical Field

The V-level will save time and money by eliminating the back and forth movement, that is used to retrieve the plumb or level of a 90 degree angle. In addition, an exact square can be derived of two objects at a 90 degree angle.

### BRIEF SUMMARY OF INVENTION

The V-Level will; vertically plumb, horizontally level, square walls and ceilings, as well as meausure.

The V-Level can also be used for inside and outside corners.

### DETAILED DESCRIPTION OF THE INVENTION

The V-level specifications are as follows;

Length being two feet, and each side being two inches in width.

Although, a second level would appear to stand along side, it creates a V-level appearance.

The V-level bubbles will be placed as follows;

Two bubbles adjacent to each other at the exact center. Two bubbles five inches from the top, and two bubbles five inches from the bottom, centered adjacent to each other.

Four recessed handles are provided;

Two handle holds for each side, allowing a user to hold and read the V-level with complete accuracy. Top of the handle hold, being at six and one half inches, and ending at ten and a half inches, from the top and bottom of the V-level. Size of the handle hold, four inches in heigth by one inch in width.

Three quarter inch hang holds are provided at each end to secure from damage.

What I claim as my Invention is:

1. Place the V-level in the corner, and simply read the bubbles to obtain the plumb, level, measurement or square of walls, ceilings, corners, and floors. Almost unlimited abilities.
Improve speed and quality of production, ‘thus more money’.
